(19) United States
(12) Patent Application Publication
(10) Pub. No.: US 2011/0191488 A1
(43) Pub. Date: Aug. 4, 2011

(54) NETWORK MEDIA PROCESSING DEVICE AND NETWORK MEDIA DISPLAY SYSTEM

(75) Inventors: Hung Sheng Wong, Hsinchu City (TW); Ching Chang Shih, Hsinchu City (TW); Min Chuan Wan, Hsinchu City (TW)

(73) Assignee: XGI TECHNOLOGY, INC, Hsinchu City (TW)

(21) Appl. No.: 12/696,824

(22) Filed: Jan. 29, 2010

(51) Int. Cl. G06F 15/16

(52) U.S. Cl. 709/231

(57) ABSTRACT

A network media processing device includes a network connection module and a graphics processor. The network connection module is electrically connected to the graphics processor directly. The network connection module is used for connecting to a local area network (LAN). Through the LAN, a host may transmit or broadcast digital image data to the network connection module. The network media processing device can receive media data transmitted by the network with a very simple hardware construction. Therefore, the use convenience can be greatly improved when media data is transmitted using a LAN.

### BACKGROUND

1. Field of Invention

The present invention relates to a processing device and a display system, and more particularly to a network media processing device and a network media display system.

2. Related Art

With the evolution of network technology and popularization of network products, various data can be propagated boundlessly. Among various network applications, the transmission of media data using a network is a common application. The transmission of media data using the network may be applied in remote video or image broadcasting.

FIG. 1 is a block diagram of a media processing device under a personal computer (PC) architecture in the prior art. Referring to FIG. 1, the media processing device comprises a central processing unit (CPU) 81, a network connection module 82, a south bridge chip 83, a north bridge chip 84, a graphics processor 85, a read only memory (ROM) 86, and a cache 87.

The south bridge chip 83 and the north bridge chip 84 are connected to the CPU 81, and serve as interfaces for connecting the CPU 81 to the external. The north bridge chip 84 is suitable for connecting to peripheral components with high throughput, and the south bridge chip 83 is suitable for connecting to peripheral components with low throughput. The graphics processor 85 may be connected to or integrated into the north bridge chip 84. The network connection module 82 may be connected to or integrated into the south bridge chip 83.

In addition, the ROM 86 and the cache 87 are also connected to the north bridge chip 84. The ROM 86 is used for storing firmware required by the components. The cache 87 is used for storing various instructions of the CPU 81.

Generally speaking, in order to display media data transmitted by a network on a display device, the CPU 81, the south bridge chip 83, and the north bridge chip 84 are required to control the data access. After receiving the media data, the network connection module 82 transmits the media data to the graphics processor 85 through the interfaces of the south bridge chip 83 and the north bridge chip 84. The graphics processor 85 decodes image signals to generate display signals, and sends them to the display device for displaying the image.

In addition, the above CPU 81, network connection module 82, south bridge chip 83, north bridge chip 84, and graphics processor 85 may also be integrated into the same chip using the system on chip (SOC) technology. Although the integration into one chip reduces the number of chips that are used, the CPU 81, the network connection module 82, and the graphics processor 85 differ greatly in basic design architecture, and it is rather difficult for chip designers or manufacturers to integrate these components into the same chip.

The above system is very complex in terms of design. The firmware and drivers of the components need to be updated in case of redesign or correction of problems of the system. In addition, more complex system architecture and more components used by the system result in higher manufacturing cost of the system. Therefore, the use convenience of transmitting media data using the network and competitiveness of relevant products are greatly discounted.

### SUMMARY

Accordingly, the present invention is a network media processing device for solving the above problems.

The present invention provides a network media processing device, which comprises a network connection module and a graphics processor. The network connection module is used for receiving a network signal and interpreting the network signal into a digital image data. The graphics processor is directly connected to the network connection module, and used for operating on the digital image data and outputting a video signal.

The network media processing device may be applied in a network media system. The network media system comprises a network connection module, a graphics processor, and a display device. The graphics processor and the network connection module are embedded in the display device. The network connection module is used for receiving a network signal and interpreting the network signal into a digital image data. The graphics processor is directly connected to the network connection module, and used for operating on the digital image data and outputting a video signal to the display device.

In the network media processing device according to an embodiment of the present invention, after the network connection module receives a network signal and interprets it into image data, the network connection module transmits the image data to a graphics processing module. Thereby, the network media processing device can receive media data transmitted by a network with a very simple hardware construction. Therefore, the use convenience can be greatly improved when media data is transmitted using the network. In addition, the network media processing device may be embedded in a display device so as to increase the added value of the display device, thereby enhancing the competitiveness of display device products in the market.

### BRIEF DESCRIPTION OF THE DRAWINGS

The present invention will become more fully understood from the detailed description given herein below for illustration only, and thus are not limitative of the present invention, and wherein:

FIG. 1 is a block diagram of a media processing device under a PC architecture in the prior art;

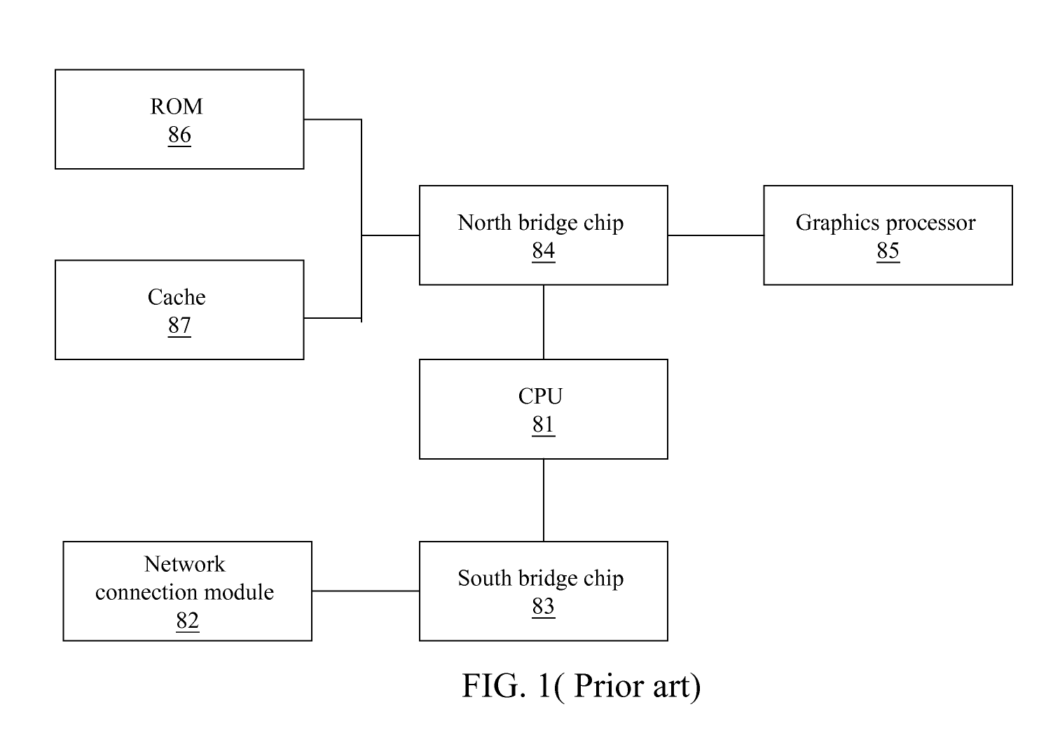

FIG. 2 is a system block diagram of the present invention;

FIG. 3 is a schematic view of a network packet format in the present invention;

FIG. 4A shows data fields of Configure Read/Write in the present invention;

FIG. 4B shows data fields of IO Read/Write and Memory Read/Write in the present invention;

FIG. 5 is a block diagram of a graphics processor in the present invention; and

FIG. 6 is a view of a network media display system in the present invention.

### DETAILED DESCRIPTION

The detailed features and advantages of the present invention are described below in great detail through the following embodiments, the content of the detailed description is sufficient for those skilled in the art to understand the technical content of the present invention and to implement the present invention there accordingly. Based upon the content of the specification, the claims, and the drawings, those skilled in the art can easily understand the relevant objectives and advantages of the present invention. The following embodiments are intended to describe the present invention in further detail, but not intended to limit the scope of the present invention in any way.

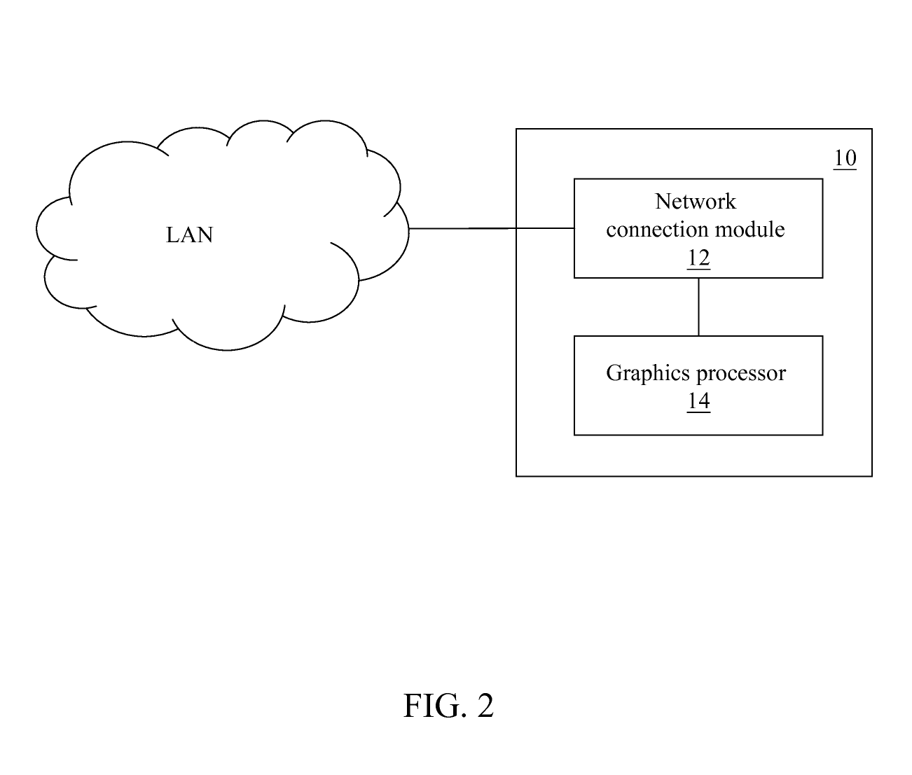

FIG. 2 is a system block diagram of the present invention. Referring to FIG. 2, a network media processing device 10 provided in the present invention comprises a network connection module 12 and a graphics processor 14. The network connection module 12 is electrically connected to the graphics processor 14 directly.

The network connection module 12 is used for connecting to a local area network (LAN). In LAN system, multiple network connection modules 12 and multiple hosts may be connected to each other through hubs, switches, or routers. Through the LAN, the host may transmit or broadcast digital image data to the network connection module 12.

The host may be a PC or a server. The PC or server uses specific encoding software or hardware, for example, H.264 encoding software or an image processing acceleration device, to encode image files so as to reduce a data volume thereof. Afterwards, the host converts the image files into a network streaming format, divides the image files into a series of packets, and adds header information for controlling packet delivery to the front of the packets.

Since a plurality of hosts or network media processing devices 10 may be connected to the LAN at the same time, in order to ensure the network speed, the hubs, switches, or routers all function to enhance the signal strength and manage the network.

In the network, data transmission is achieved by decomposing data into a plurality of packets, transmitting the packets from a source end to a destination end, and then combining the received packets at the destination end. For image data transmission such as on-line broadcasting, users require fluent video and audio in viewing and listening, and part of errors caused by packet transmission faults can be obviously reduced through image processing, so the requirement for network transmission emphasizes the high speed and fluency of transmission.

The network connection module 12 may be a bridge device. The network connection module 12 is used for receiving a network signal and interpreting the network signal into a digital image data. According to different physical layer transmission media, the network connection module 12 herein may comprise an Ethernet transceiver module, a wireless network transceiver module, an optical network transceiver module, a power line network transceiver module, and a coaxial cable network transceiver module.

The Ethernet transceiver module and the optical network transceiver module may be IEEE 802.3 series communication protocols stipulated by the international Institute of Electrical and Electronics Engineers (IEEE). The wireless network transceiver module may be IEEE 802.11a/b/g/n communication protocol. The power line network transceiver module and the coaxial cable network transceiver module may be G.HN communication protocols stipulated by the International Telecommunication Union (ITU).

The above communication protocols have different characteristics. Generally speaking, with dedicated lines, a wired network has a stable communication quality and is suitable for transmitting high-quality image data; on the other hand, a wireless network is convenient in use, but has no dedicated lines because it transmits electromagnetic waves through the air. The quality of transmission through the wireless network is less stable.

Besides, in order to deliver image data more efficiently, the network connection module 12 may initiate an interrupt request (IRQ). The network connection module 12 may determine whether the image data needs to be received. When the image data does not need to be received, the network connection module 12 may continuously maintain a waiting state. When it is determined that the image data needs to be received, the network connection module 12 sends the IRQ to the host end. The host transmits the image data to the network connection module 12 only upon receiving the IRQ.

In order to transmit the image data using a LAN packet format, the image data needs to be transmitted in a special data format.

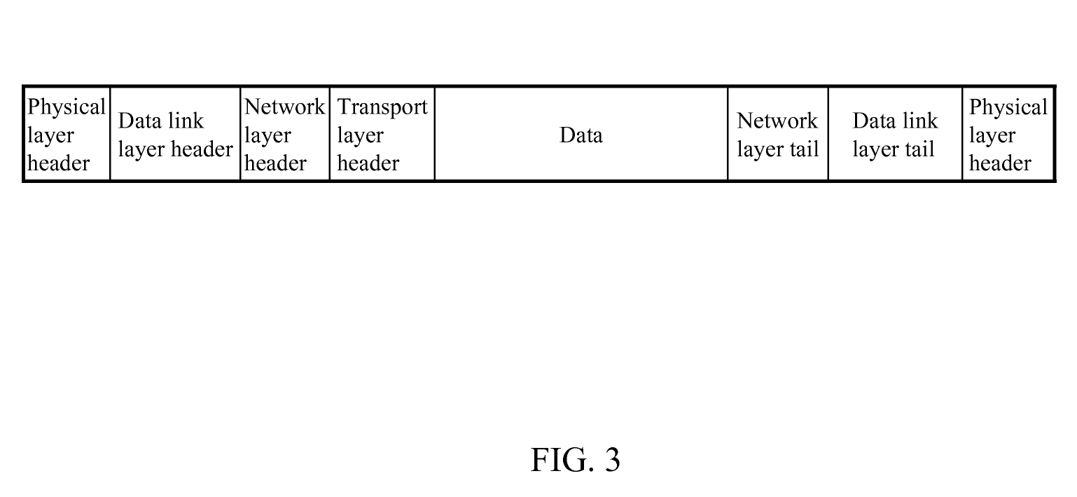

FIG. 3 is a schematic view of a network packet format. Referring to FIG. 3, the data format comprises header, data, and tail. The header comprises a physical layer header, a data link layer header, a network layer header, and a transport layer header. The header is used to deliver various parameters and set values. The data section is image data. The tail is used to check whether transmitted data is correct.

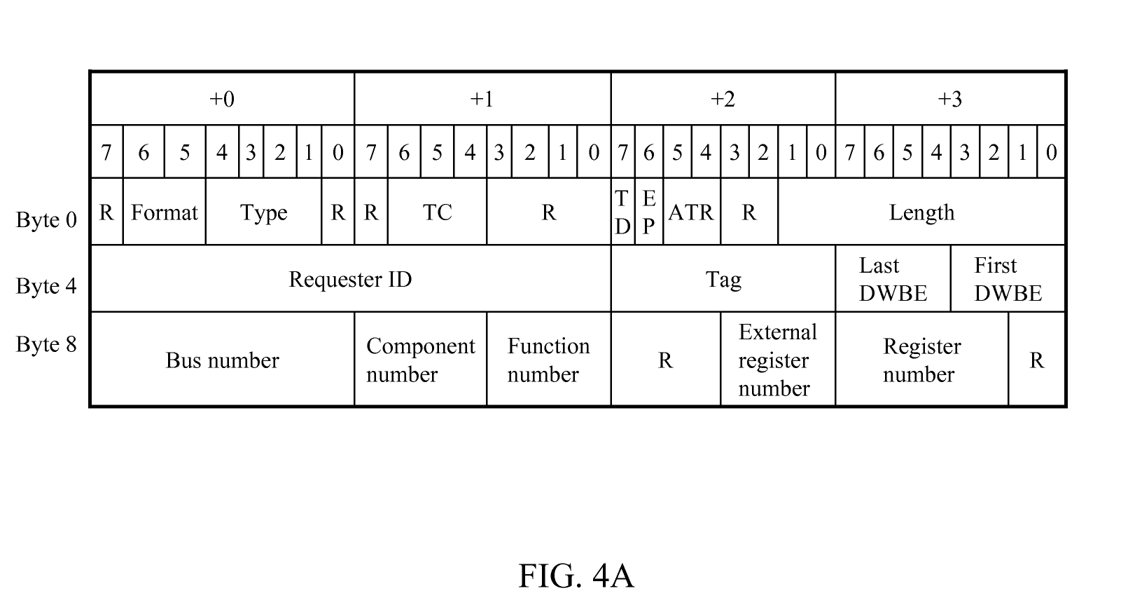

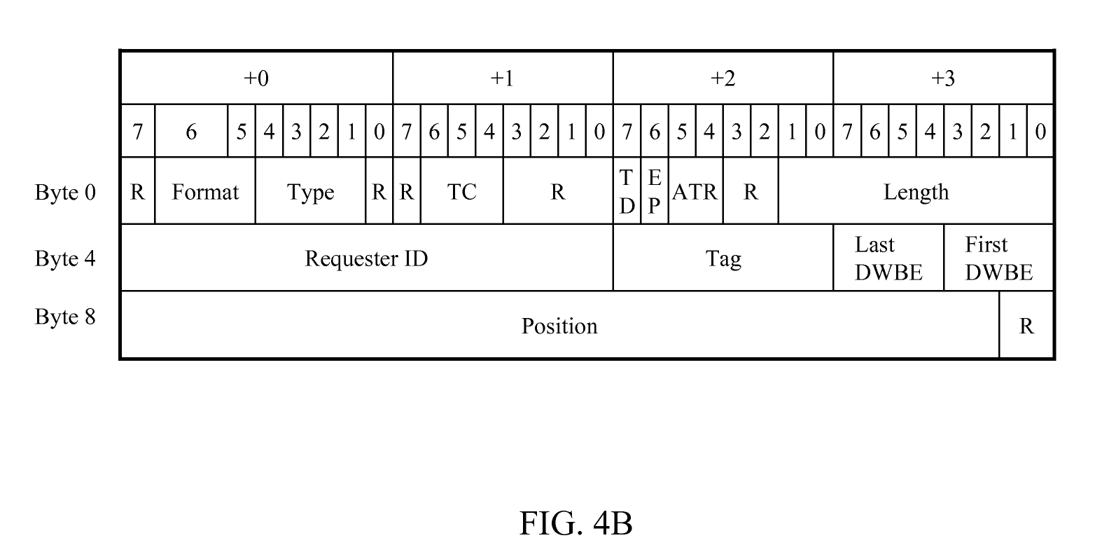

Referring to FIGS. 4A and 4B, FIG. 4A shows data fields of Configure Read/Write, and FIG. 4B shows data fields of IO Read/Write and Memory Read/Write. The lengths of the Configure Read/Write and the IO Read/Write are both four double words, i.e., 128 bits. The length of the Memory Read/Write is at most 1024 bits due to the limitation of the length of an Ethernet packet.

Header data fields of the Configure Read/Write, IO Read/Write, and Memory Read/Write data comprise a format field, a type field, a memory-write tag field, a 3-bit traffic class (TC) field, a transaction description (TD) field, an endpoint (EP) field, an ATR field, a length field, a requester identifier (ID) field, a last double word byte enable (DWBE) field, and a first DWBE field. The last DWBE field contains byte enables for a last double word of a service request. The first DWBE field contains byte enables for a first double word of a service request. The 7^{th} bit of the 0^{th} byte, the 0^{th} to 3^{rd} bits and the 7^{th} bit of the 1^{st} byte, the 2^{nd} and 3^{rd} bits of the 2^{nd} byte, and the 0^{th} and 1^{st} bits of the 11^{th} byte are sent as reserved bits.

The format field is used to control data storage or reading. When the format field is “00”, data may be stored in a memory. When the format field is “01”, data may be read from a memory.

The type field is used to distinguish different types. When the type field is “00100”, the data is of the Configure Read/Write type. When the type field is “00010”, the data is of the 10 Read/Write type. When the type field is “00000”, the data is of the Memory Read/Write type.

The header data fields of the Configure Read/Write, 10 Read/Write, and Memory Read/Write data may respectively be used to enable different components of the graphics processor 14.

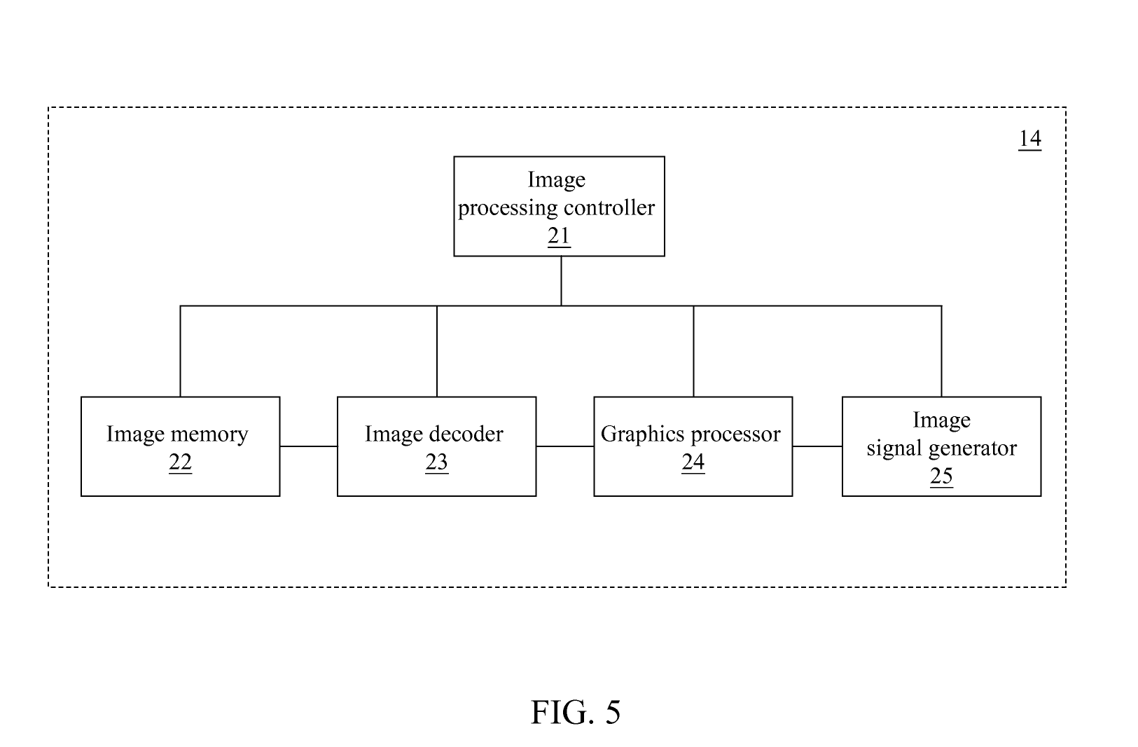

FIG. 5 is a block diagram of the graphics processor 14. Referring to FIG. 5, the graphics processor 14 mainly comprises an image processing controller 21, an image memory 22, an image decoder 23, a graphics processor 24, and an image signal generator 25.

The image processing controller 21 is a core component of the graphics processor 14 and mainly functions to operate on processing signals between the image memory 22, the image decoder 23, and the image signal generator 25. After receiving image data, the image processing controller 21 stores the image data in the image memory 22.

The image memory 22 may be a cache, a flash, a dynamic random access memory (DRAM), or other components having memory function.

The image data may be compressed or uncompressed image data. The image decoder 23 decodes various compressed image data. For example, the compressed image data may be in a Moving Picture Experts Group 2 (MPEG2) format, an MP4 format, an H.264 format, a video codec 1 (VC-1) format, a 3GP format, or other types of image data formats. The image decoder 23 captures image files from the image memory 22 and decodes the above various compressed image data into uncompressed image data according to appropriate algorithms.

The graphics processor 24 provides accelerated processing, such as block color fill and block move, for two-dimensional or three-dimensional images in the image processing. The graphics processor 24 uses a parallel computation method to perform specific and complex steps in two-dimensional or three-dimensional images simultaneously, thus greatly reducing the operation time, and achieving the efficacy of accelerated processing.

The image signal generator 25 performs image modulation processing on each pixel color processed by the graphics processor 24 and then provides a video signal output to a display. The image signal generator 25 comprises a color look up table (LUT), a multiplexer (MUX), a gamma controller, a digital to analog converter (DAC), a dither, and so on.

The format of the video signal output may be a computer standard or a television standard. The computer standard is, for example, a video graphics array (VGA) standard, an extended graphics array (XGA) standard, or a widescreen ultra extended graphics array (WUXGA) standard. The television standard is, for example, a phase alternating line (PAL) standard, a National Television System Committee (NTSC) standard, a high definition television (HDTV) standard, or other video signal output standards.

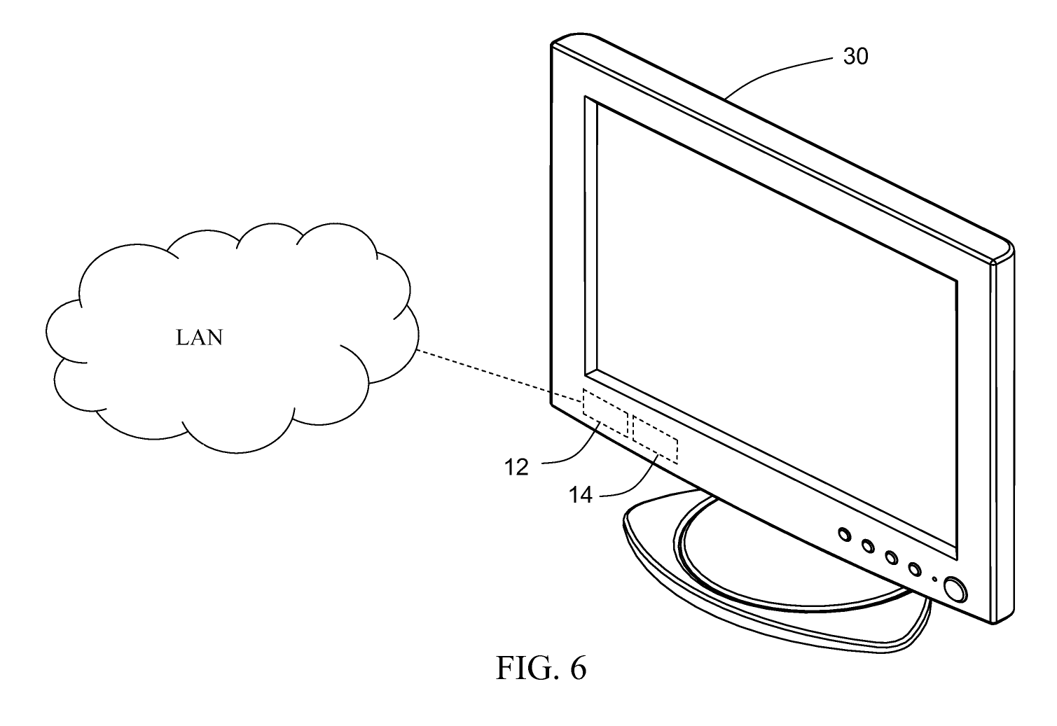

The above network media processing device 10 may be applied in a network media system. FIG. 6 is a view of a network media display system. Referring to FIG. 6, the network media system comprises a network connection module 12, a graphics processor 14, and a display screen 30. The network connection module 12 is used for receiving a network signal and interpreting the network signal into a digital image data. The graphics processor 14 is directly connected to the network connection module 12 and used for operating on the digital image data and outputting a video signal to the display screen 30. The graphics processor 14 and the network connection module 12 are embedded in the display device.

The display screen 30 may be, but not limited to, a liquid crystal display (LCD) screen, a plasma display screen, a light emitting diode (LED) display screen, or a cathode ray tube display screen. The display screen may have, on one side thereof, a network input port through which various different network signals can be input. The display screen 30 may also have an antenna externally connected thereto or built therein for receiving wireless signals, so as to be connected to a LAN wirelessly.

On the other hand, the display screen 30 may also be connected to the LAN by a power line. When a power plug of the display screen 30 is inserted into a socket, the network connection module 12 inside the display screen 30 may obtain the network signal supplied from the host by filtering alternating current (AC) signals, convert the network signal into a play signal through the graphics processor 14, and play the play signal on the display screen 30.

In the network media processing device 10 provided in an embodiment of the present invention, after the network connection module 12 receives a network signal and interprets it into image data, the network connection module 12 transmits the image data to the graphics processor 14. Thereby, the network media processing device 10 can receive media data transmitted by a network with a very simple hardware construction. Therefore, the use convenience can be greatly improved when media data is transmitted using the network. In addition, the network media processing device 10 may be embedded in a display device so as to increase the added value of the display device, thereby enhancing the competitiveness of display device products in the market.

What is claimed is:

1. A network media processing device, comprising:
a network connection module, for receiving a network signal and interpreting the network signal into a digital image data; and
a graphics processor, directly connected to the network connection module, for operating on the digital image data and outputting a video signal.

2. The network media processing device according to claim 1, wherein the network connection module is a bridge device.

3. The network media processing device according to claim 1, wherein the digital image data is the digital image data in an H.264 format, a Moving Picture Experts Group 2 (MPEG-2) format, an MPEG-4 format, a video codec 1 (VC-1) format, or a 3GP format.

4. The network media processing device according to claim 1, wherein the digital image data is a uncompressed digital image data.

5. A network media display system, comprising:
a display device;
a network interface, for receiving a network signal and interpreting the network signal into a digital image data; and
a graphics processor, directly connected to the network interface, for operating on the digital image data and outputting a video signal to the display device.

6. The network media display system according to claim 5, wherein the network interface is embedded in the display device, and the graphics processor is embedded in the display device.

7. The network media display system according to claim 5, wherein the network interface is a bridge network interface.

8. The network media display system according to claim 5, wherein the digital image data is the digital image data in an H.264 format, a Moving Picture Experts Group 2 (MPEG2) format, an MPEG-4 format, a video codec 1 (VC-1) format, or a 3GP format.

9. The network media display system according to claim 5, wherein the digital image data is a uncompressed digital image data.
